(19) United States
(12) Patent Application Publication
(10) Pub. No.: US 2014/0278942 A1
(43) Pub. Date: Sep. 18, 2014

(54) SOCIAL NETWORK BASED MONETIZED CONTENT SYSTEM

(71) Applicant: Donald A. Buffamanti, San Diego, CA (US)

(72) Inventor: Donald A. Buffamanti, San Diego, CA (US)

(21) Appl. No.: 14/213,320

(22) Filed: Mar. 14, 2014

Related U.S. Application Data
(60) Provisional application No. 61/794,394, filed on Mar. 15, 2013.

(51) Int. Cl. G06Q 50/00; G06Q 30/02

(52) U.S. Cl. CPC G06Q 50/01; G06Q 30/0273
USPC 705/14.45; 705/14.69; 705/14.7; 705/14.71; 705/319

(57) ABSTRACT

An online social network or webpage that allows users to create accounts with a corresponding user page and compensates the users based upon traffic that views the posted content or referrals from the user page. The amount of compensation a user account receives is displayed on the user page, encouraging other users to maintain their own user pages, constantly strive to discover interesting content, and strive for large number of followers in order to similarly obtain compensation. A trust rating is generated and displayed on each user page to reduce fraudulent links and users with spam or negative intent. A user can upgrade to a premium account, allowing advertisers to bid for advertising space upon their user page. Statistical data is generated for each user page and is available to advertisers for aiding in the selection of user pages of most interest to those advertisers for bidding on advertising space.

### CROSS REFERENCE TO RELATED APPLICATIONS

This application claims the benefit of U.S. Provisional Patent Application Ser. No. 61/794,394, filed on Mar. 15, 2013, entitled “SOCIAL NETWORK BASED MONETIZED CONTENT SYSTEM,” which is hereby incorporated by reference in its entirety.

### BACKGROUND

1. Field of the Invention

The present invention relates generally to a system or process for compensating individuals based upon their social online presence via a proprietary ad serving network and affiliate payment system. More particularly, the present invention relates to a system or process allowing individuals to post and promote items, photographs, or any digitally displayable content on an Internet or other network-based social network and be compensated based upon the traffic or referrals to products originating from their user account hosted on the social network.

2. Description of the Related Art

A traditional Internet-based social network allows an individual to create a free user account and post items of interest to their account (e.g., digital discoveries, photos, trending products, videos (such as TV shows, movies, etc.), articles, reviews, news, music, shopping deals, personal updates, etc.) for other users browsing the social network to view. These social networks commonly allow a user with an account to post text messages, photographs, and/or videos on their assigned user page that is then made available for searching or browsing by others who utilize the service. Users may also be permitted to “follow” other users of the service, thereby allowing a person quick access to other user's pages that they find of particular interest. Indeed, users who put in substantial time or effort into maintaining their pages commonly have hundreds, if not thousands, of other users following them or subscribing to their content. The revenue due to the attention and traffic such a user page generates is generally not shared with the user responsible for creating the interesting content, but rather is taken by the provider of the social network for maintaining the server infrastructure or as profit.

Advertisers of various products have been particularly keen to place banner ads or other forms of visual or audible advertisements on these social networks due to the massive amounts of unique viewers that participate in the networks on a daily basis. Unfortunately, since users of social networks commonly do not see any revenue from this advertisement activity, there is little incentive to grow the number of followers or subscribers to one's user page other than the pride in creating content that large numbers of individuals are interested in viewing. Moreover, certain individuals who already have a strong presence on the Internet (e.g., celebrities such as movie or music stars, athletes, etc.), use social network as a branding mechanism, but similarly lose out on the large amounts of advertising revenue obtained based upon the popularity of their user pages. Some companies have attempted to include users in the revenue stream but providing referral links or codes that blog-writers or others with a web presence may embed in their webpages to uniquely identify referral traffic, but this solution requires extra effort and computer sophistication that many users on the Internet either cannot be bothered with or do not understand.

Thus, it would be desirable to have an improved social network or other Internet or online-based website that makes it possible to easily and simply share revenue from advertisers with the users responsible for generating the traffic or referrals that advertisers are paying for. The improved social network or website would desirably allow any of its users to opt for monetization of their account and not be hassled with additional steps that must be taken corresponding to the content of their user page in order to be compensated. In addition, the improved social network or website would desirably allow other users and/or advertisers to monitor specific information or statistics of another user as either a source of comparison among users of the network or as a means for identifying those with particular advertising potential.

### SUMMARY

The present invention is related to a system and process for providing a monetized social network or online-based webpage or a social network and/or online-based webpage with ratings of trustworthiness. In one embodiment of the present invention, a method of providing a user with a monetized account for a social network may include creating a user account for the user in a memory, providing storage space for use by the user account to establish a user page, compensating the user, and displaying the compensation to the user on the user page.

In another embodiment of the present invention, a social network having monetized accounts may include a memory configured to store at least one user account, and a processor coupled with the memory. The processor may be configured to establish a user page for the user account, determine an amount of compensation to be paid to the user account, and display the amount of compensation on the user page.

In still another embodiment of the present invention, a method of providing a user with an account on a network may include establishing a user account for the user in a memory, establishing a user page associated with the user account, displaying a piece of content on the user page, determining a trust rating for the piece of content and displaying the trust rating for the piece of content to a viewer of the user page.

### BRIEF DESCRIPTION OF THE DRAWINGS

Other systems, methods, features, and advantages of the present invention will be or will become apparent to one with skill in the art upon examination of the following figures and detailed description. It is intended that all such additional systems, methods, features, and advantages be included within this description, be within the scope of the present invention, and be protected by the accompanying claims. Component parts shown in the drawings are not necessarily to scale and may be exaggerated to better illustrate the important features of the present invention. In the drawings, like reference numerals designate like parts throughout the different views, wherein:

FIG. 1 shows a block diagram of a system incorporating a monetized social network according to an embodiment of the present invention;

FIG. 2 shows a display layout for a user page of a monetized social network according to an embodiment of the present invention;

FIG. 3 shows a display layout for statistics for a user account of a monetized social network according to an embodiment of the present invention; and

FIG. 4 shows a flowchart of a process of a monetized social network according to an embodiment of the present invention.

### DETAILED DESCRIPTION

The detailed description of exemplary embodiments herein makes reference to the accompanying drawings and pictures, which show the exemplary embodiment by way of illustration and its best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

Turning first to FIG. 1, a block diagram of a system 100 is shown that incorporates a monetized social network. The system 100 includes a central server 105 and a plurality of end user systems or devices (110, 115, 120). The central server 105 includes a processor 150 connected with a memory 160. The memory 160 includes a database 170 for the storing of user accounts and their associated data (e.g., trust rating, type of account, content of display page, etc.), as discussed in further detail herein. In an alternative embodiment, the central server 105 may comprise a plurality of distributed servers or computer systems. The processor 150 is configured to interface with the memory 160 (e.g., access the database 170 and execute software commands) of the monetized social network. The end user devices (110, 115, 120) may be desktop computers, laptops, mobile devices (such as smart phones or tablets), or any other type of electronic device or system that is capable of transmitting and/or receiving data from the central server 105.

Displays (112, 117, 122) may be connected to each of the end user devices (110, 115, 120), respectively, so that information communicated from the central server 105 to the end user devices (110, 115, 120) can be viewed by a user. Thus, users at the end user devices (110, 115, 120) may search or browse the information stored in the memory 160 of the central server 105 and view certain of that information in a visual format upon their respective displays (112, 117, 122). Although a plurality of end user devices (110, 115, 120) are shown by FIG. 1, in an alternative embodiment, any number of end user devices (i.e., one or more end user devices) may be configured to connect with the central server 105.

Turning next to FIG. 2, an exemplary display layout 200 for a user page 202 of a monetized social network is shown. The monetized social network may include features that are the same as or similar to features previously described by the system 100 of FIG. 1. The user page 202 may be displayed within a web browser (e.g., Internet Explorer, Google Chrome, Mozilla Firefox, etc.), within an application (e.g., a smartphone or tablet application), or by any other means of display of the display layout 200 to a user. In an alternative embodiment, certain elements of the display layout 200 may be modified, added, or removed from those shown in FIG. 2 in order to display additional or modified data or information that may differ from that data explicitly described herein.

Information block 205 may be disposed along a top left portion of the user page 202 and include information corresponding to the user and/or the user's account that is responsible for managing, controlling, creating, and/or otherwise manipulating the content of the user page 202. For example, information block 205 may include the account name, the name of individual or entity who created the account, a short textual description of the account, the date of account creation, the duration the account has been active, the geographic location of the individual who created the account, etc. The information block 205 may also include a trust rating for the account, as discussed in greater detail herein. Information block 207 may be disposed adjacent to information block 205 and include information corresponding to other user accounts that are following (e.g., linked to, saved as a favorite, apprised of updates, etc.) the account responsible for user page 202 or to other user accounts that are being followed by the account responsible for user page 202. Thus, a linked web of various user pages may be displayed and easily traversable by a user browsing the user page 202, furthering the social aspect of the monetized social network.

Beneath information blocks 205 and 207, information blocks 220 and 210 are displayed. Information block 210 may contain an amount of revenue or compensation paid to the individual or entity that created the account responsible for user page 202. This compensation or revenue may have been generated due to advertisements placed on the user page from an advertiser. In one embodiment, such advertiser may pay a predetermined amount of money to the monetized social network, a portion of which is distributed to the various user accounts based upon traffic or referral hits. For example, if a particular user account is responsible for 100 k unique page views per day, an advertiser with an ad that is located on such page would pay a predetermined amount of money, based upon the number of page views (unique or otherwise), for such advertising exposure. In another example, if a particular user account is responsible for 10 clicks upon an ad that refers to an advertiser's webpage or product listing, that advertiser would pay a predetermined amount of money, based upon the number of clicks, for such referrals.

The total amount of compensation received by the account holder due to these payments is displayed to all users that view the user page 202 in information block 210. In an alternative embodiment, the amount of compensation may be displayed by other means in addition to or in replacement of the total amount (e.g., compensation per day, compensation per month, etc.). Thus, users of the monetized social network can easily see how much money a particular user is generating based upon their visiting that user page 202. This can become a source of bragging rights among users and can encourage other users to actively maintain their own user pages once becoming aware of the amount of revenue that could be paid to them upon creating a user page with content of interest to a large number of other users.

Information block 220 includes other statistics or information about the user account responsible for the user page 202. For example, information block 220 may include the ranking of the user page 202 based upon an amount of page views, the number of “likes” or “dislikes” the user page 202 has accumulated, the number of times the user page 202 has been “shared” by other users across the network, etc. Any of a variety of statistics or information may be accumulated, generated, or otherwise determined for the user page 202, for example, based on the user page 202 creation date, amount of data or content shared, user views of the user page 202, number of followers of the user page 202, amount of compensation associated with the user page 202, etc.

Information blocks 205, 207, 210, and/or 220 may be populated with content that is substantially generated or determined by the software of the monetized social network itself. Beneath these information blocks (205, 207, 210, 220), a user-generated content portion takes up a substantial portion of the user page 202. The user-generated content is the content generally created and/or linked to and/or shared by the account holder of the user page 202. This content may draw in other users to view or browse the statements, photographs, or videos stored as part of the user page 202. In some embodiments, all or a portion of the content (e.g., particular photographs, videos, and/or audio) that is displayed on the user page 202 may be sold (e.g., for a set, bidding, or negotiable fee). For example, a user may flag (e.g., via a setting in the user account associated with the user page 202 and/or via a specific tag for a particular piece of content) that the content is available for sale and/or license. The rights conveyed may be any of a variety of types (e.g., sale of all rights to the content, sale of some rights, such as only the right to use, sale or license to display the content for a particular period of time, etc.). Such sale provides another method of monetizing the user account associated with the user page 202 and the owner or operator of the social network may take a portion of the payment from such sale and/or charge the user a fee to enable the account for sale of content.

As shown, information blocks (230, 231, 232, 233, 234, 235, 236, 237, 238, 239, 240, 241) are a plurality of categories generated by the account user and may contain photographs, videos, textual documents, audio files such as music or music videos, etc. that correspond to such categories. For example, information block 230 may be labeled by the account user as a category corresponding to automotive vehicles and contain photographs, textual comments, and/or webpage links of cars, trucks, etc. while information block 231 may be labeled by the account user as a category corresponding to home items and contain photographs, textual comments, and/or webpage links of products for decorating a house, condo, or apartment unit. The categories may be predetermined by the software of the monetized social network and/or may be set, selected, or otherwise determined by a user managing the user page 202.

The photographs, videos, or other content on display on the user page 202 in information blocks (230, 231, 232, 233, 234, 235, 236, 237, 238, 239, 240, 241) may have links embedded in them such that a user browsing the user page 202 can click on the content and be directed to a different webpage or destination on the Internet. For example, a picture of a new Mercedes Benz automobile may contain a link that directs to the Mercedes Benz webpage or press release about the new automobile if or when a user clicks upon the picture. In this way, a user browsing the user page 202 may seek out further information regarding items of interest that are found on the user page 202 by simply clicking on the respective piece of content being displayed. In an effort to prevent fraudulent links (e.g., a photograph of a Mercedes Benz automobile linking to an unrelated product, such as a diet pill), each user account of the monetized social network will have a corresponding trust rating. As previously disclosed, this trust rating may be displayed in information block 205 so that users browsing the user page 202 know if the account responsible for the user page 202 has a history of fraudulent linking displayed on the user page 202 level in order to prevent users from being misdirected to content unrelated to what caught their eye on the content portion of the user page 202.

The trust rating may be generated or maintained by aggregating input from users who view the user page 202. For example, a user who is tricked by a fraudulent link on the user page 202 may click an “untrustworthy” button that is permanently displayed on the user page 202 (e.g., located adjacent to the trust rating in information block 205, at a top of the user page 210 and/or anywhere else upon the user page 202, and/or displayed on a user's screen, such as via a pop-up or banner who is or was viewing the user page 202). As more users click the “untrustworthy” button on the user page 202, the trust rating for the account responsible for the user page 202 begins to diminish. In certain embodiments, only registered users (e.g., users with an active account) of the monetized social network may have access to the “untrustworthy” button in an effort to prevent anonymous abuse of the trust rating. In an alternative embodiment, if the trust rating for a user account grows too negative or low, one or more pieces of information, data, or content on the user page 202 may begin to dim or “washout” on the page until such information, data, or content eventually disappears.

For example, a user page 202 may contain a number of clickable photographs located thereon. If one of the photographs, when clicked, leads to an unexpected online location (e.g., a spam page), an “untrustworthy” button may pop-up or display in an overlay or banner that can be clicked by the visitor to the user page 202. Each photograph or piece of content may have a separate “untrustworthy” button associated therewith, the buttons either aggregating to an overall trust rating for the user account, or a distinct trust rating may be determined for each piece of content. If viewers of the user page 202 click the “untrustworthy” button more than a predetermined number of times for a particular photograph or piece of content, that particular piece of content may begin to dim and/or disappear after its trust rating reaches a predetermined level. Similarly, in another embodiment, based on the trust rating for a user account, one or more pieces of information, data, or content on the user page 202 may additionally or alternatively change size (e.g., grow in size or shrink in size). For example, as a piece of content is repeatedly marked as “untrustworthy,” the piece of content may take up less and less real estate upon the user page 202, alerting future viewers that is less trustworthy or worthwhile than the surrounding content. Likewise, as a piece of content is viewed and not marked as “untrustworthy” or is otherwise flagged as desirable by viewers (e.g., through the use of a “like” or “share” button), the piece of content may take up more and more real estate upon the user page 202, indicating to future viewers that it is particularly trustworthy or worthwhile when compared to the surrounding content.

Turning next to FIG. 3, a display layout 300 for a statistics page 302 for a user account of a monetized social network is shown. The statistic page 302 and/or the monetized social network may include features that are the same as or similar to those features as previously described by FIGS. 1 and/or 2. The statistics page 302 may be displayed within a web browser (e.g., Internet Explorer, Google Chrome, Mozilla Firefox, etc.), within an application (e.g., a smartphone or tablet application), or by any other means of display of the display layout 300 to a user. In one embodiment, overview statistics and/or more general statistical or account data, such as total revenue earned or total page views, may be displayed upon a main user page (e.g., user page 202 of FIG. 2) that may be clicked in order to load or view the statistics page 302 that contains more detailed or further statistical information or account data. In an alternative embodiment, certain elements of the display layout 300 may be modified, added, or removed from those shown in FIG. 3 in order to display additional or modified data or information from that explicitly described herein.

The statistics page 302 may load for viewing by a user upon clicking on a link or graphic displayed on a user page (e.g., the user page 202 of FIG. 2). The statistics page includes a plurality of information blocks (310, 320, 330). In an alternative embodiment, greater or fewer information blocks may be used. Information blocks (310, 320, 330) may include statistics for the user account (e.g., data relating to the influence that the user page has among certain demographics). Information blocks (310, 320, 330) may graphically display the statistical data in a viewable format (graphs, charts, etc.) that makes the data easily digestible and/or understandable for viewers. For example, information blocks (310, 320, 330) may detail the dollars earned by the account holder, the number of items referred, viewed and/or sold due to the account holder, the most viewed posts of the account holder, the most viewed comments of the account holder, the ages of users visiting the user page, the date users visited the user page, the number of page visits (unique or otherwise), the type of device or web browser used to visit the user page, zip codes of visiting users, geographic location of visiting users, how long visitors have had active accounts with the social network, etc. By making this information available to all users and/or advertisers of the social network, the specific traits or makeup of viewers to a user page can be determined, either for advertising purposes or to help the account holder or other users tailor their content so that it will be most desirable to the most viewers.

FIG. 4 shows a flowchart of a process 400 of a monetized social network according to an embodiment of the present invention. Certain aspects of the monetized social network may include features that are the same as or similar to those features as previously described by FIGS. 1, 2, and/or 3. For example, the social network may include a processor that communicates with a memory as part of a computer system or server setup that executes software for implementing the process 400 described in greater detail herein.

At step 405, a user account is created for a user desiring access to the social network. This may be initiated by the user filling out a web-based form or via a smartphone application and submitting this form or data to a computer system or server for account creation. In one embodiment, the computer system or server may include a database stored in memory that saves such user account data. At step 410, the user is asked whether they wish to monetize the user account. This step may be performed by a pop-up box that is displayed to the user or may be a setting that can be toggled within an options, settings, or preferences screen or menu corresponding to the user account creation or as an option should they want to monetize the account in the future once the account has been created.

If the user does not wish to monetize the user account, operation continues to step 415 and storage space is provided to the user for no charge. For example, a user may be permitted 2 GB of storage for uploading of various media (e.g., videos, pictures, text, audio files such as music or music videos, etc.) to the memory of the social network computer system or server. In an alternative embodiment, no storage space limitation may be imposed and users would be free to upload as much data or information as desired. In an alternative embodiment, the social network may charge the user for use of the storage space or may charge the user for use of additional storage space that is made available above a predetermined amount.

However, if the user does wish to monetize the user account, operation continues to step 420. The same as or similar to the above, storage space is provided to the user for no charge, the same or similar as described above. For example, a user may be permitted 2 GB of storage for uploading of various media (e.g., videos, pictures, text, audio files such as music or music videos, etc.) to the memory of the social network computer system or server. In an alternative embodiment, no storage space limitation may be imposed and users would be free to upload as much data or information as desired.

With a monetized user account, the online traffic and/or referrals from the user are tracked or determined in order to compensate the user accordingly as indicated at step 425. For example, advertisers may be charged a fee (e.g., a flat, monthly fee) by the operator of the social network for the placement of banner ads, videos, or other marketing media upon the user pages hosted by the social network. User pages that are more popular with viewers would thus have a larger amount of page views or online traffic associated with them that is exposed to the marketing media of these advertisers. As discussed in greater detail below, these page views or traffic information may be used as a basis for compensation of social network users. In another example, advertisers may be charged a fee by the operator of the social network every time a viewer of the social network is referred to a webpage or is directed to and/or purchases a particular product advertised. Such referrals may be made by clicking advertisement banners created by the advertisers on user pages, clicking links created by users themselves on user pages, entering referral codes into text boxes upon checkout when making online purchases, etc. Again, as discussed in greater detail below, this referral information may be used as a basis for compensation of social network users.

At step 430, the operators of the social network compensate users with monetized accounts based upon the traffic information and/or referral information determined in step 425. This compensation may be performed on a monthly basis. In an alternative embodiment, any timeframe for compensation may be used (e.g., weekly, annual, etc.). In one example, a user responsible for a user page may be compensated with a predetermined percentage of advertiser revenue received by the social network based upon a predetermined number of unique user page views and/or referrals within a one month period. The precise percentage of advertiser revenue that is allocated and provided to a particular user may be determined by any of a variety of payout schemes as desired (e.g., based on percentage of total traffic). In certain embodiments, incentives to users may be provided by increasing the revenue share that is dependent on traffic and/or referrals (e.g., if a user's traffic crosses a predetermined threshold or level, that user's revenue share or percentage will increase). In this manner, top performers, such as celebrities with a potentially large number of followers or viewers will see an increased level of revenue than more modest users.

At step 435, the compensation provided to the user responsible for the user page as discussed above in step 430 is displayed on the user page. As previously discussed, this allows users or viewers of the social network to identify the amount of revenue other users are generating from their page content. In an alternative embodiment, the compensation may not be displayed and/or may be displayed based upon the owner or manager of the user page opting to allow its display to some or all users that may visit the user page. At step 440, a trust rating is determined for the user. The trust rating may be determined by aggregating trustworthiness ratings by other viewers, as previously discussed. In certain embodiments, the user may be allowed to ascertain which other viewers impacted their trust rating. In certain embodiments, the user may also or alternatively be allowed to dispute all or a part of their trust rating. At step 445, the trust rating determined for the user in step 440 is displayed on the user page of the user. In certain embodiments, when certain thresholds of the trust rating, good and/or bad, are attained, appropriate graphical icons may be displayed next to the trust rating number, for example, stars or trash cans. In another embodiment, trust ratings may be categorized by color so that rising stars can change as well as falling stars. In still another embodiment, the trust rating may correspond to a particular piece of content on the user page in addition to, or in replacement of, a trust rating for the user or the user page as a whole.

At step 447, a relative user earnings/compensation or traffic ranking may be displayed on the user page in relation to other users of the social network and/or other users of the social network that are linked (e.g., following/followed) to the user page. In certain embodiments, this may be displayed in addition to or in replacement of the display of user compensation on the user page (see, e.g., step 435). In one embodiment, if a user is within a top percentage of earners on the social network, a relative number indicating the ranking, position, or other indicator among other top earners may be displayed (e.g., “Top 10,” “Top 1%,” etc.). At step 449, similar to the previous discussion, a republication license (e.g., web, digital rights, reprint rights, etc.) for at least a portion of the user-created or posted content on a user page may be made available for the user. Thus, a user may receive a fee from another user or third party that wishes to use or otherwise license the user of content, such as photos or videos that are displayed. For example, if the user takes a photograph and posts it for display on the user page (e.g., a photograph of a landscape, such as the beach), and a third party (e.g., an individual, company, etc.) desires to use that photograph (e.g., for a corporate power-point presentation, etc.), the third party may purchase a republication license to use the photograph. In this fashion, the same as previously discussed, a user may receive compensation not only from traffic/referrals to their user page, but also from third parties wishing to purchase rights to the user-posted content.

At step 450, it is determined whether the user wishes to become a premium member or otherwise upgrade their user account to allow for bidding from advertisers, as discussed in greater detail below. If not, operation continues to step 420 wherein storage space is still offered or maintained for the user and traffic/referrals/trustworthiness is tracked or otherwise determined. However, if the user does wish to become a premium member, operation continues to step 455 and a form of payment is accepted or received by the operator of the social network from the user. The user may also have options to promote their accounts using dollars earned from their presence or by adding money to their accounts, such as via credit cards or PayPal-like accounts.

At step 460, the user account is enabled to participate in a bidding process for advertiser marketing materials. Such an account may see increased revenue beyond what is typically possible with only a monetized account. In some embodiments, a predetermined threshold may limit the availability of upgrading to a premium account (e.g., a user's page must have above a predetermined number of page views or followers, etc.). Interested advertisers may be provided with a list of premium user accounts and have access to the associated statistics or demographics for each of those accounts, the same or similar as previously discussed. Interested advertisers may be required to pay an additional fee to the operator, manager, and/or owner of the social network in order to have access to the bidding process and/or to pick and choose by user data such as age, influence rating, trust rating, etc.

In certain embodiments, interested advertisers may be able to search the list of premium user accounts based upon predetermined and/or modifiable criteria (e.g., search for greatest number of page views, search for greatest number of followers under a particular age, etc.). When an interested advertiser locates a user account of particular interest for marketing one or more products, the advertiser may post a bid for placement of their marketing material on that user's user page. The current high bid may be displayed for interested advertisers during the bidding process so that it is known how high a bid must be in order to remain competitive. After a predetermined amount of time or before a predetermined date, the winning bid among all interested advertisers bidding for that user's page is selected and permits the winning advertiser with a location to place their marketing media upon the user's page.

In certain embodiments, users may be given a degree of control over which advertisements may be placed or may bid for placement upon their page. For example, if a particular user feels negatively about the consumption of alcohol, he or she may not allow bidding from advertisers for alcohol beverages. In another example, if a particular user feels negatively about a particular company, he or she may prevent any bids from that particular company. In an alternative embodiment, a user may be permitted to reject a winning bid after the bidding process has concluded.

The previous description of the disclosed examples is provided to enable any person of ordinary skill in the art to make or use the disclosed methods and apparatus. Accordingly, the terminology employed throughout should be read in a non-limiting manner. Various modifications to these examples will be readily apparent to those skilled in the art, and the principles defined herein may be applied to other examples without departing from the spirit or scope of the disclosed method and apparatus. The described embodiments are to be considered in all respects only as illustrative and not restrictive and the scope of the invention is, therefore, indicated by the appended claims rather than by the foregoing description. All changes which come within the meaning and range of equivalency of the claims are to be embraced within their scope. Skilled artisans may implement the described functionality in varying ways for each particular application, but such implementation decisions should not be interpreted as causing a departure from the scope of the disclosed apparatus and/or methods.

What is claimed is:

1. A method of providing a user with a monetized account for a social network comprising:
creating a user account for the user in a memory;
providing storage space for use by the user account to establish a user page;
compensating the user; and
displaying the compensation to the user on the user page;

2. The method of claim 1 further comprising:
determining an amount of traffic that visits the user page;
providing the amount of traffic that visits the user page to an advertiser; and
receiving payment from the advertiser for displaying an ad on the user page, the payment based on the amount of traffic that visits the user page,
wherein the compensating the user includes providing a percentage of the payment received from the advertiser to the user.

3. The method of claim 2 wherein the percentage is a first percentage if the traffic is less than a first threshold and wherein the percentage is a second percentage, higher than the first percentage, if the traffic is equal or greater than the first threshold.

4. The method of claim 1 further comprising:
displaying an advertisement from an advertiser on the user page;
determining an amount of referrals from the user page due to the advertisement;
receiving payment from the advertiser for displaying the advertisement on the user page, the payment based on the amount of referrals from the user page due to the advertisement,
wherein the compensating the user includes providing a percentage of the payment received from the advertiser to the user.

5. The method of claim 1 further comprising:
determining a trust rating for the user account; and
displaying the trust rating for the user account on the user page.

6. The method of claim 5 wherein the determining the trust rating for the user account is based on feedback from at least one viewer of the user page.

7. The method of claim 1 further comprising:
displaying a piece of content on the user page;
determining a trust rating for the piece of content; and
displaying the trust rating for the piece of content to a viewer of the user page.

8. The method of claim 1 further comprising:
determining information about traffic that visits the user page; and
providing the information about the traffic to an advertiser.

9. The method of claim 8 wherein the information about the traffic that visits the user page includes at least one of: amount of traffic that visits the user page, age demographics of the traffic that visits the user page, gender demographics of the traffic that visits the user page, types of devices used for the traffic that visits the user page, or geographic location of the traffic that visits the user page.

10. The method of claim 1 further comprising:
enabling bidding for the at least one advertiser to advertise on the user page;
receiving bids from the at least one advertiser to advertise on the user page; and
determining the at least one advertiser with the highest bid to advertise on the user page.

11. The method of claim 10 further comprising receiving payment from the user for the enabling bidding for at least one advertiser to advertise on the user page;

12. A social network having monetized accounts comprising:
a memory configured to store at least one user account; and
a processor coupled with the memory and configured to:
establish a user page for the user account,
determine an amount of compensation to be paid to the user account, and
display the amount of compensation on the user page.

13. The system of claim 12 wherein the processor is further configured to:
determine a highest bid from at least one advertiser to advertise on the user page; and
determine a trust rating for a piece of content displayed on the user page.

14. A method of providing a user with an account on a network comprising:
establishing a user account for the user in a memory;
establishing a user page associated with the user account;
displaying a piece of content on the user page;
determining a trust rating for the piece of content; and
displaying the trust rating for the piece of content to a viewer of the user page.

15. The method of claim 14 wherein the piece of content on the user page is one of: a static image, an animated image, or a video.

16. The method of claim 14 further comprising modifying the piece of content based on the trust rating for the piece of content.

17. The method of claim 16 wherein the modifying the piece of content for display on the user page includes resizing the piece of content for display on the user page.

18. The method of claim 17 wherein the piece of content is reduced in size if the trust rating is below a predetermined threshold

19. The method of claim 16 wherein the piece of content is changed in color if the trust rating is below a predetermined threshold.

20. The method of claim 16 wherein the piece of content is automatically deleted from the user page if the trust rating is below a predetermined threshold.
